(19) United States
(12) Patent Application Publication
(10) Pub. No.: US 2011/0098996 A1
(43) Pub. Date: Apr. 28, 2011

(54) Sifting Models of a Subsurface Structure

(76) Inventors: David Nichols, Houston, TX (US); Konstantin S. Osypov, Houston, TX (US)

(21) Appl. No.: 12/906,402

(22) Filed: Oct. 18, 2010

Related U.S. Application Data
(60) Provisional application No. 61/254,928, filed on Oct. 26, 2009.

(51) Int. Cl. G06G 7/48

(52) U.S. Cl. 703/6

(57) ABSTRACT

Multiple models are generated based on information relating to uncertainties of model parameters, where the models are consistent with preexisting data regarding a subsurface structure. A system receives, on a continual basis, information collected as an operation is performed with respect to the subsurface structure. The multiple models are recursively sifted to progressively select smaller subsets of the models as the collected information is continually received.

### CROSS REFERENCE TO RELATED APPLICATIONS

This application claims the benefit under 35 U.S.C. §119(e) of U.S. Provisional Application Ser. No. 61/254,928 entitled “SIFTING EARTH MODELS WHILE DRILLING,” filed Oct. 26, 2009, which is hereby incorporated by reference.

This application is related to U.S. application Ser. No. 12/354,548, filed Jan. 15, 2009, U.S. Patent Publication No. 2009/0184958, which is hereby incorporated by reference.

### BACKGROUND

Various techniques (e.g., electromagnetic or seismic techniques) exist to perform surveys of a subsurface structure for identifying subsurface elements of interest. Examples of subsurface elements of interest in the subsurface structure include hydrocarbon-bearing reservoirs, gas injection zones, thin carbonate or salt layers, fresh-water aquifers, and so forth.

One type of electromagnetic (EM) survey technique is the controlled source electromagnetic (CSEM) survey technique, in which an electromagnetic transmitter, called a “source,” is used to generate electromagnetic signals. Surveying units, called “receivers,” are deployed on a surface (such as at the sea floor or on land) within an area of interest to make measurements from which information about the subsurface structure can be derived. The receivers may include a number of sensing elements for detecting any combination of electric fields, electric currents, and/or magnetic fields.

A seismic survey technique uses a seismic source, such as an air gun, a vibrator, or an explosive to generate seismic waves. The seismic waves are propagated into the subsurface structure, with a portion of the seismic waves reflected back to the surface (earth surface, sea floor, sea surface, or wellbore surface) for receipt by seismic receivers (e.g., geophones, hydrophones, etc.).

Measurement data (e.g., seismic measurement data or EM measurement data) can be analyzed to develop a model of a subsurface structure. The model can include, as examples, a velocity profile (in which velocities at different points in the subsurface structure are derived), a density profile, an electrical conductivity profile, and so forth.

### SUMMARY

In general, according to some embodiments, multiple models are generated based on information relating to uncertainties of model parameters, where the models are consistent with preexisting data regarding a subsurface structure. A system receives, on a continual basis, information collected as an operation is performed with respect to the subsurface structure. The multiple models are recursively sifted to progressively select smaller subsets of the models as the collected information is continually received.

Other or alternative features will become apparent from the following description, from the drawings, and from the claims.

### BRIEF DESCRIPTION OF THE DRAWINGS

Some embodiments are described with respect to the following figures:

FIG. 1 is a flow diagram of a process of recursively sifting multiple models based on information collected as an operation is performed with respect to the subsurface structure, in accordance with some embodiments;

FIG. 2 illustrates an example arrangement for performing a survey operation with respect to a subsurface structure; and

FIG. 3 is a flow diagram of an uncertainty analysis workflow, in accordance with some embodiments.

### DETAILED DESCRIPTION

Traditionally, a goal of imaging a subsurface structure based on seismic or electromagnetic (EM) survey data is to focus the data and provide a relatively high-quality subsurface image. Later, more emphasis was placed on delivering a proper depth image that is as close as possible to the actual subsurface structure. To achieve the latter goal, it may no longer be enough to simply focus the data; a realistic anisotropic earth model should be developed to perform such imaging. An anisotropic earth model refers to a model of the subsurface structure in which properties of the subsurface structure differ in different directions.

Surface seismic and/or EM data (hereinafter referred to generally as “survey data” collected by survey receivers at or above the earth surface) alone may not be able to uniquely resolve all the parameters of an anisotropic subsurface structure. Often, even if well data (data collected by well logging) is available, it still may not be possible to resolve all the parameters of the anisotropic subsurface model.

To develop an accurate subsurface model, it is useful to understand the impact of the uncertainty in the estimates of a velocity model and anisotropy on the subsurface structure. This applies not only to the depth data for a depth migration, but also the lateral positioning of events in the subsurface image.

Even with efforts to combine multiple sources of available data, there can still be ambiguity in subsurface models. For example, multiple different velocity models can exist that explain observed survey data. The result is uncertainty of the true positions of events in subsurface images based on survey data. These uncertainties can lead to exploration risk (e.g., trap failure), drilling risk (e.g., drying wells), and/or volumetric uncertainties (in which there is relatively large uncertainty in the estimated volume of subsurface fluids of interest, such as hydrocarbons). While the underlying ambiguity may not be fully eradicated, a quantified measure of uncertainties may provide deeper understanding of the risks and related mitigation plans to address the risks.

In accordance with some embodiments, uncertainty analysis techniques are provided to allow a set of models that fit all available data equally well to be provided to a user, such that the user is allowed to select the most geologically plausible solution. The selection of the most plausible model from among a set of models can be based on any a priori information.

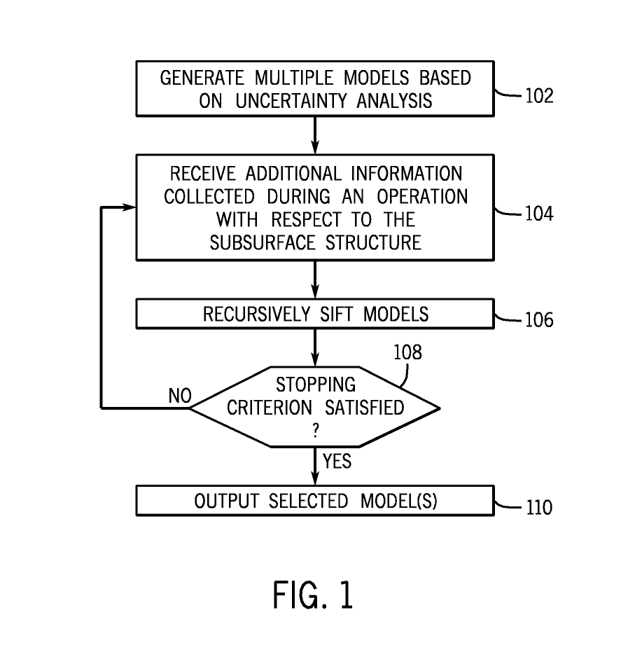

FIG. 1 is a flow diagram of a process according to some embodiments. A system generates (at 102) multiple anisotropic models of a subsurface structure based on uncertainty analysis, where the multiple models are consistent with preexisting data regarding the subsurface structure. The preexisting data can include surface survey data (e.g., seismic and/or EM survey data collected by survey receivers at or above a surface over the subsurface structure of interest), well log data, and other data relating to the subsurface structure.

The multiple models based on the preexisting data are associated with ambiguity, since even though the multiple models are based on all available sources of data relating to the subsurface structure, there can be many different models that are consistent with the preexisting data. The uncertainty analysis performed at 102 includes quantifying measures of uncertainties of events (presence of various subsurface elements) in a subsurface structure. The uncertainty analysis allows for a determination of information relating to uncertainties of estimated model parameters. The model ambiguity is a main cause for uncertainty of the true positions of events in subsurface images, and these uncertainties can lead to various risks as noted above. While the underlying ambiguity may not be fully eradicated, quantified error measures of such uncertainties provide deeper understanding of risks and related mitigation plans.

In some implementations, the multiple models generated (at 102) based on the uncertainty analysis are posterior models (e.g., velocity models that provide a velocity profile in the subsurface structure, structural models that define structures in the subsurface structure, etc.).

To allow a user to select from among the multiple models that are consistent with the preexisting data, additional information is received (at 104), where the additional information is collected on a continual basis as an operation is performed with respect to the subsurface structure. In some implementations, the operation that is performed with respect to the subsurface structure includes drilling a well into the subsurface structure, with logging performed while drilling. The logging involves using sensors in a logging tool (positioned in the well during drilling) to collect information regarding properties of the subsurface structure surrounding the drilled wellbore. Receiving the additional information on a “continual basis” means that such information continues to be received while the operation with respect to the subsurface structure is ongoing.

In accordance with some embodiments, the multiple models are recursively sifted (at 106) to progressively select smaller subsets of the multiple models as the additional information is continually received. As the well is drilled, the logging tool continues to collect information. The continually received information can then be used in repeated iterations of tasks 104 and 106 to further reduce the population of candidate models that were initially generated at 102. A determination is made (at 108) whether a stopping criterion has been satisfied. For example, the stopping criterion is satisfied if L or less models have been selected at 106, where L≧1. Alternatively, the stopping criterion is satisfied if a predefined number of iterations of 104 and 106 have been performed. If the stopping criterion has not been satisfied, tasks 104 and 106 are repeated in the next iteration. If the stopping criterion has been satisfied, then the FIG. 1 procedure outputs (at 110) the selected model(s), as selected by the sifting (106).

In this manner, the number of possible models can be reduced down to a few (e.g., one), which can then be used as the model(s) that most accurately characterize(s) the subsurface structure.

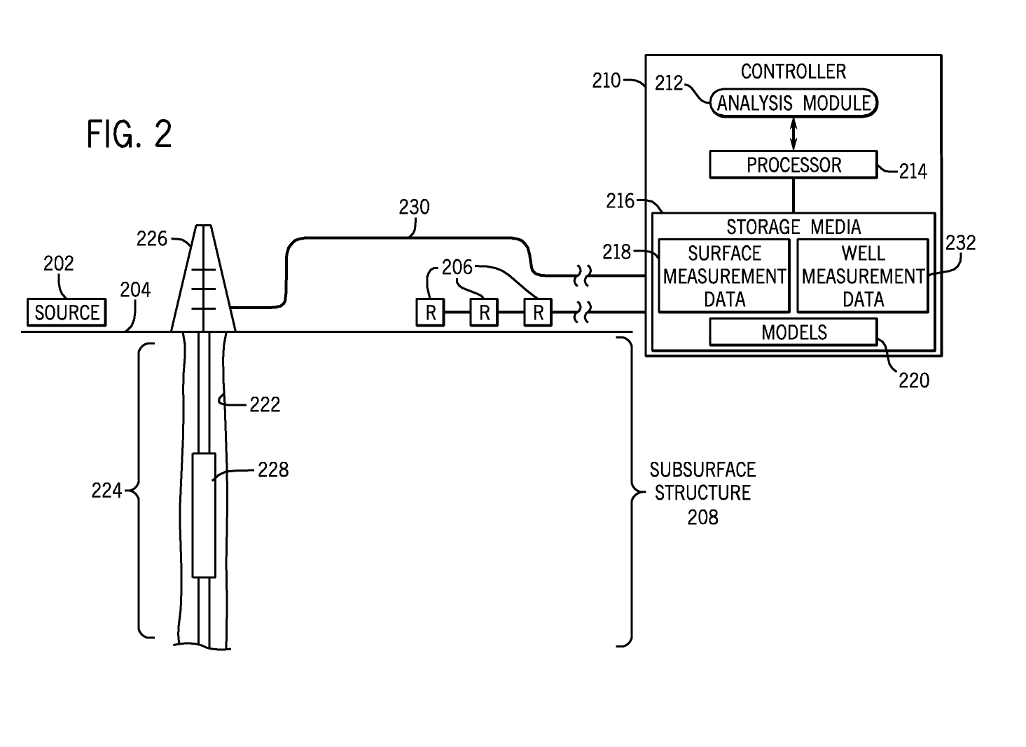

FIG. 2 illustrates an example arrangement of performing a land-based survey operation. Although reference is made to land-based survey operations, it is noted that techniques according to some implementations can also be applied to marine survey operations, where survey equipment is provided in a body of water.

A survey source 202 (e.g., seismic source or EM source) is placed at an earth surface 204. Also, survey receivers (e.g., seismic receivers or EM receivers) 206 are also placed at the earth surface 204. The survey source 202 generates survey signals that are propagated into a subsurface structure 208. The signals are affected by or reflected by subsurface elements in the subsurface structure 208, where the affected signals or reflected signals are detected by the survey receivers 206.

Measurement data collected by the survey receivers 206 are provided to a controller 210, either over a wired or wireless link. The controller 210 has an analysis module 212 executable on one or multiple processors 214. The analysis module 212 is executable to perform various tasks according to some implementations, such as tasks depicted in FIG. 1 or tasks discussed further below.

The processor(s) 214 is (are) connected to a storage media 216, for storing information such as surface measurement data 218 from the survey receivers 206. In addition, models 220, generated by the analysis module 212 according to some embodiments based on uncertainty analysis, can also be stored in the storage media 216. As discussed in connection with FIG. 1 above, recursive sifting can be performed with respect to the models 220.

To allow for sifting from among the models 220, additional information relating to an operation performed with respect to the subsurface structure 208 is collected by the controller 210. As depicted in FIG. 2, such further operation involved drilling of a wellbore 222 by a drill string 224. The drill string 224 extends from wellhead equipment 226, and has a logging tool 228 for recording information with respect to properties of the subsurface structure 208 during the drilling operation. The recorded information by the logging tool 228 can be communicated to the wellhead equipment 226, and communicated over a link 230 (wired or wireless link) to the controller 210. The information from the logging tool 228 is stored as well measurement data 232 in the storage media 216 of the controller 210.

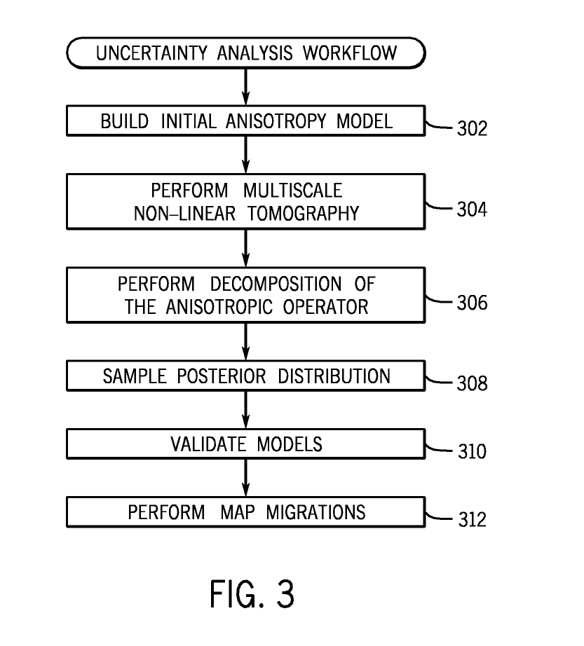

To generate multiple posterior models (e.g., velocity models, structural models, etc.) of the subsurface structure 208, an uncertainty analysis workflow is performed, as depicted in FIG. 3. The workflow of FIG. 3 can be performed by the analysis module 212 of FIG. 2, for example. As depicted in FIG. 3, the uncertainty analysis workflow starts with building (at 302) an initial anisotropy model calibrated with available well data and steered between wells with given geological structural interpretation. In this task, a geologically reasonable prior distribution for the anisotropic parameters is defined; for example, plausible geologic concepts are considered in terms of shapes and patterns of the subsurface's anisotropic behavior. Also allowable ranges of velocity, ε, and δ perturbations are obtained from rock physics analysis.

Thus, a mean initial (prior) model is constructed. The prior covariance matrix is parameterized as C_{P}=PP^{T}, where P is the shaping preconditioner. In general, the initial model could be different from the mean prior model, but in this example workflow it is assumed they are the same. The preconditioner corresponds to a 3D smoothing and/or steering operator with parameters defined from geologic and rock physics considerations.

Next, multiscale non-linear tomography is performed (at 304), which is an iterative process involving migrating the data, picking common-image-point (CIP) gathers and dips, ray tracing, and solving a relatively large, but sparse system of linear equations. The data vector, Δz, corresponds to data perturbations with respect to the initial model and can include CIP picks, checkshots, a walk-away VSP, markers and other data types. A least-squares solver (e.g., LSQR) is applied to the system,

$$[ \begin{matrix}{D}^{- 1 / 2} LP \\ I\end{matrix} ] Δ {x}^{′} = [ \begin{matrix}{D}^{- 1 / 2} Δ z \\ 0\end{matrix} ] ,$$

where L is the (anisotropic) tomographic operator, PΔx′=Δx is the update vector, and Δx′ is the update vector in preconditioned space. Both update vectors include three-dimensional (3D) perturbations for velocity, ε and δ. The obtained solution corresponds to the minimization of the objective function, S, defined by

$$S = \frac{1}{2} [ ( Δ z - L Δ x ) {D}^{- 1} ( Δ z - L Δ x ) + Δ {xC}_{0}^{- 1} Δ x ] . \qquad ( 1 )$$

One of the key elements of the posterior-distribution sampling process is the interplay between the geo-model space (defined by a velocity, ε and δ vector) and the so-called preconditioned space (defined such that application of the preconditioner to a vector from this space produces the vector from the geo-model space). Uncertainty analysis is applied after the last non-linear iteration of tomography when the solution has converged and driven the misfit to an acceptable, predefined value. This value could be used to recalibrate D, and, optionally, L-curve analysis (i.e., plotting two terms from Eq. 1 as an x-y plot in linear or logarithmic scale) could be used for this purpose.

Next, the workflow performs (at 306) decomposition of the anisotropic tomographic operator L produced by the tomography (304). Further details regarding such eigen-decomposition on a Fisher information operator is provided in U.S. Patent Publication No. 2009/0184958, referenced above. U.S. Patent Publication No. 2009/0184958 discusses techniques for updating models of a subsurface structure that involve computing a partial decomposition of an operator that is used to compute a parameterization representing an update of a model. More specifically, eigen-decomposition is performed on a Fisher information operator in the preconditioned space F=(LP)^{T}D⁻¹(LP) by use of Lanczos iterations. Thus, the resulting decomposition is F=UΛU^{T}, where U is a matrix of eigenvectors and Λ is the corresponding diagonal matrix of eigenvalues.

The posterior covariance matrix by definition is the inverse of the sum of the Fisher operator and the inverse of the prior covariance matrix. Because the prior covariance matrix in the preconditioned space is the identity matrix, it has full rank, and thus the posterior matrix also has full rank. Since the model vector typically has more than one million elements, rather than explicitly storing the posterior covariance matrix whose size is the square of the model vector, it is more practical to store random samples of it. For this objective, two components of Cₚ, the posterior covariance matrix in the preconditioned domain, are considered. The first component is U(Λ+I)⁻¹U^{T} and it corresponds to the eigen-decomposition of F (as per U.S. Patent Publication No. 2009/0184958, referenced above). The second component is I−UU^{T} and it corresponds to the null-space projection operator (as per U.S. Patent Publication No. 2009/0184958, referenced above). By combining these two components, the following is obtained:

$${C}_{P} = I - {UU}^{T} + {U ( Λ + I )}^{- 1} {U}^{T} = 1 - U \frac{Λ}{Λ + 1} {U}^{T}$$

Next, each random sample vector, Δ\hat{x}′, drawn from the posterior distribution is computed (at 308) as:

Δ\hat{x}′=Cₚ^{1/2}r=└I−U{I−(Λ+I)^{-1/2}}U^{T}┘r.

Here r is a random vector sampled from a unit multinormal distribution. Application of the preconditioner to the resultant vectors in effect maps the sample models pulled from the posterior distribution into the geo-model space. The posterior probability for each sampled model could be assessed by calculating objective function S by applying Eq. 1. The resultant models are all valid solutions to the original tomography problem: they both keep the misfit at the noise level and satisfy the original prior information and geological constraints.

The models are then validated (at 310) by checking the predicted residual moveout. This moveout should remain in the allowed tolerance level, and if not, this serves as an indication of violating linearity assumption.

The sampled posterior covariance matrix can be used for uncertainty analysis of a model. This analysis can include the visualization and comparison of different parts of the posterior covariance matrix, like its diagonal, rows, and quadratic forms (in case of anisotropy). The analysis can be performed for comparing various prior assumptions while varying a prior covariance matrix and for comparing different acquisition geometries.

Next, map migrations of horizons of interest are performed (at 312) for the set of obtained perturbations in velocity, ε and δ. The resulting set of target horizon instances is statistically analyzed and structural uncertainty estimates are derived.

Having performed the iterative eigen-decomposition once, multiple posterior models are derived, from which a model (or L models, where L≧1) can be selected by performing the recursive sifting at 106 that is part of the procedure depicted in FIG. 1. Once a set of posterior models (e.g., velocity models) have been derived, the recursive sifting process (104, 106) can be applied to select from among the multiple models.

In accordance with some implementations, a marker-based workflow can be used, where the posterior models have associated horizons that correspond to marker horizons at various depths. A “marker” refers to a particular subsurface element, and a “marker horizon” refers to a position of the subsurface element. In the context of some implementations, the markers represent subterranean elements proximate a wellbore (e.g., 222 in FIG. 2) that is being drilled. A set of marker horizons associated with a model refer to different subsurface elements at different depths in the subsurface structure 208.

As the wellbore is being drilled, only those models where the corresponding marker horizons (of the models) match the actual marker horizons within a given bound (e.g., predefined tolerance range) are kept. Actual marker horizons are determined based on the recorded information collected by the logging tool 228 of FIG. 2. The remaining models (those models whose marker horizons do not match actual marker horizons) from the initial set of posterior models are discarded. The population of models will become smaller as each marker horizon is passed during the drilling process. A benefit of the marker-based workflow of sifting models is that the workflow does not require actual access to the models. Instead, the marker-based workflow uses marker horizons associated with the models. Maintaining and processing horizon information involves much less storage and processing resources than having to maintain and process the underlying models.

In alternative implementations, instead of using the marker-based workflow, a checkshot-based workflow can be used to recursively sift models. Checkshot involves vertical seismic profiling, where one or more seismic sources are placed at the earth surface, and seismic receivers are placed in a wellbore. Activation of the one or more seismic sources at the surface causes seismic waves to be propagated through the subsurface structure 208 to the seismic receivers in the wellbore. The seismic waves as detected by the seismic receivers are associated with respective travel times. In implementations in which the posterior models are velocity models, a comparison can be made to determine whether travel times as predicted by respective models match the actual travel times in the checkshot. Only those models with predicted travel times that match the checkshot time to within a predefined error range are kept, while the remaining models are discarded.

By using some embodiments of the invention, a more accurate model of a subsurface structure can be obtained, based on sifting among multiple posterior models that are consistent with preexisting data.

The analysis module 212 includes machine-readable instructions which are loaded for execution on a processor (such as processor(s) 214. A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
generating, by a system having a processor, a plurality of models of a subsurface structure based on information relating to uncertainties of model parameters, wherein the plurality of models are consistent with preexisting data regarding the subsurface structure;
receiving, by the system on a continual basis, information collected as an operation is performed with respect to the subsurface structure; and
recursively sifting the plurality of models to progressively select smaller numbers of the plurality of models as the collected information is continually received.

2. The method of claim 1, wherein receiving the collected information comprises receiving the collected information as a well is drilled into the subsurface structure.

3. The method of claim 1, wherein generating the plurality of models comprises generating anisotropic models of the subsurface structure.

4. The method of claim 1, wherein generating the plurality of models comprises generating velocity models or structural models.

5. The method of claim 1, wherein recursively sifting the plurality of models comprises:
associating marker horizons with the corresponding ones of the plurality of models;
as the collected information is received, comparing the marker horizons to actual locations of elements in the subsurface structure; and
based on the comparing, progressively eliminating ones of the plurality of models.

6. The method of claim 1, wherein recursively sifting the plurality of models comprises:
associating modeled travel times of signals in corresponding ones of the plurality of models;
as the collected information is received, comparing the modeled travel times to actual travel times of signals; and
based on the comparing, progressively eliminating ones of the plurality of models.

7. The method of claim 1, wherein generating the plurality of models is based on performing an uncertainty analysis.

8. The method of claim 7, wherein performing the uncertainty analysis is based on a covariance matrix that represents the uncertainties of model parameters.

9. The method of claim 7, wherein performing the uncertainty analysis comprises performing decomposition of an anisotropic operator.

10. The method of claim 1, wherein the preexisting data comprises survey data collected by survey equipment located at or above a surface above the subsurface structure.

11. The method of claim 10, wherein the survey data comprises one or more of seismic data or electromagnetic data.

12. An article comprising at least one machine-readable storage medium storing instructions that upon execution cause a system having a processor to:
receive survey data regarding a subsurface structure collected by survey equipment;
generate a plurality of models of the subsurface structure based on information relating to uncertainties of model parameters, wherein the plurality of models are consistent with the survey data;
receive, on a continual basis, information collected as an operation is performed with respect to the subsurface structure; and
recursively sift the plurality of models to progressively select smaller numbers of the plurality of models as the collected information is continually received.

13. The article of claim 12, wherein the survey data comprises one or more of seismic survey data and electromagnetic survey data.

14. The article of claim 13, wherein receiving the information comprises receiving data collected by a logging tool in a well.

15. The article of claim 14, wherein the operation performed with respect to the subsurface structure is a drilling operation to drill the well.

16. The article of claim 12, wherein recursively sifting the plurality of models comprises:
associating marker horizons with the corresponding ones of the plurality of models;
as the collected information is received, comparing the marker horizons to actual locations of elements in the subsurface structure; and
based on the comparing, progressively eliminating ones of the plurality of models.

17. The article of claim 12, wherein recursively sifting the plurality of models comprises:
associating modeled travel times of signals in corresponding ones of the plurality of models;
as the collected information is received, comparing the modeled travel times to actual travel times of signals; and
based on the comparing, progressively eliminating ones of the plurality of models.

18. A system comprising:
a storage media to store survey data regarding a subterranean structure; and
at least one processor configured to:
generate a plurality of models of the subsurface structure based on information relating to uncertainties of model parameters, wherein the plurality of models are consistent with the survey data;
receive, on a continual basis, information collected as an operation is performed with respect to the subsurface structure; and
recursively sift the plurality of models to progressively select smaller numbers of the plurality of models as the collected information is continually received.

19. The system of claim 18, wherein to recursively sift the plurality of models, the at least one processor is configured to further:
associate marker horizons with the corresponding ones of the plurality of models;
as the collected information is received, compare the marker horizons to actual locations of elements in the subsurface structure; and
based on the comparing, progressively eliminate ones of the plurality of models.

20. The system of claim 18, wherein to recursively sift the plurality of models, the at least one processor is configured to:
associate modeled travel times of signals in corresponding ones of the plurality of models;
as the collected information is received, compare the modeled travel times to actual travel times of signals; and
based on the comparing, progressively eliminate ones of the plurality of models.
